(19) United States
(12) Patent Application Publication
(10) Pub. No.: US 2011/0190408 A1
(43) Pub. Date: Aug. 4, 2011

(54) CATALYSIS OF NATURAL OIL BASED FLEXIBLE POLYURETHANE FOAMS WITH BISMUTH COMPOUNDS

(75) Inventors: Francois M. Casati, Pfaffikon (CH); Jean-Marie Sonney, Schindellegi (CH); Herve Wuilay, Ebmatingen (CH)

(73) Assignee: Dow Global Technologies Inc., Midland, MI (US)

(21) Appl. No.: 12/675,088

(22) PCT Filed: Aug. 26, 2008
(86) PCT No.: PCT/US08/74325

§ 371 Date: Feb. 24, 2010

Related U.S. Application Data
(60) Provisional application No. 60/966,284, filed on Aug. 27, 2007.

(51) Int. Cl. C08J 9/04; C08G 18/66

(52) U.S. Cl. 521/119; 521/123; 521/155; 521/120; 521/124

(57) ABSTRACT

A process for producing a polyurethane product comprises steps of (a) supplying at least one polyisocyanate (b) supplying at least one polyol composition comprising at least about 5 weight percent based on total weight of polyols of at least one natural oil based polyol (b1) having a hydroxyl number of at most about 300 and a viscosity below about 10000 mPa·os; and (c) exposing the polyisocyanate and the polyol composition to reaction conditions such that urethane bonds are formed, wherein reaction conditions include the presence of at least one bismuth catalyst. Use of bismuth catalysts is particularly applicable to preparation of open celled, flexible polyurethane foams using polyols made from renewable resources, optionally with other polyols. The invention includes foams made by the process, including viscoelastic foams, preferably having a velvet feel.

### CROSS-REFERENCE TO RELATED APPLICATIONS

This application claims benefit of U.S. Provisional Patent Application Ser. No. 60/966,284, filed Aug. 27, 2008, entitled “Catalysis of Natural Oil Based Flexible Polyurethane Foams with Bismuth Compounds” which is herein incorporated by reference.

### BACKGROUND

The present invention pertains to a process for making polyurethane foams using polyols made from renewable resources.

Polyether polyols based on the polymerization of alkylene oxides, polyester polyols, and combinations thereof, are usually the major components of a polyurethane system together with isocyanates. Polyols optionally include filled polyols, such as SAN (Styrene/Acrylonitrile), PIPA (polyisocyanate polyaddition) or PHD (polyurea) polyols, as described in “Polyurethane Handbook”, by G. Oertel, Hanser publisher.

Polyols made from natural oils or renewable feedstocks are known. Such polyols are described by Peerman et al. in U.S. Pat. Nos. 4,423,162; 4,496,487 and 4,543,369. Peerman et al. describe hydroformylating and reducing esters of fatty acids as are obtained from vegetable oils and forming esters of the resulting hydroxylate materials with a polyol or polyamine. Higher functional polyester polyol materials derived from fatty acids are described in WO 2004/096882; WO 2004/096883. These polyester polyols are made by reacting a polyhydroxyl initiator with certain hydroxymethylated fatty acids. Others approaches for polyols based on renewable resources are described for example in Publications WO 2004/020497; WO 2004/099227; WO 2005/0176839; WO 2005/0070620 and in U.S. Pat. No. 4,640,801. Some of these polyols have been used to make flexible polyurethane foams. See, for instance WO 2004/096883, WO 2006/116456 and WO 2004/020297.

Usually the organometallic salt catalyst used to produce polyurethane flexible foams is based on tin. In some instances there is a preference for avoiding a tin catalyst for environmental reasons. In addition, it has been found that foam processing can involve an unacceptably narrow window of tin catalyst concentration between foam collapse, foam voiding (or splitting) and foam shrinkage when at least one natural oil polyol (NOP) is used in a tin-catalyzed foam formulation. The effect of cell structure, voids and foam collapses are described in Polyurethanes Chemistry and Technology, part 1 Chemistry, chapter V, Formation of Urethane Foams, by J. H. Saunders and K. C. Frisch, Interscience Publishers, a division of John Wiley and sons, NY, & London, 1962. FIG. 10, page 253 shows the “Relation between T-9 (stannous octoate) catalyst concentration and foam character in a one-shot polyether flexible foam.” These data show that voids occur at low T-9 levels and that closed cells occur at high T-9 levels. This holds true for both large (for instance, 30 cells/inch) and for finer cells (for instance, 60 cells/inch) foams. A “processing window” is the range of T-9 catalyst giving good foams, that is, without voids or unacceptable numbers of closed cells (closed cells leading to foam shrinkage or, in the better case, unacceptable reduction in airflow which will impact negatively foam comfort). Hence, the wider this processing window, the better the operation in foam manufacturing.

An operator can observe foam voiding (or splitting) during the foam production, and can correct it quickly by increasing the stannous octoate level in the formulation. Foam shrinkage, however, occurs during foam cooling, after completion of the foam manufacturing step and cannot be corrected. Shrinkage or tight foam can affect a full production batch and make it unusable. Desirably, the range of catalyst levels giving good foam would be sufficiently high to be metered accurately by a pump of a manufacturing machine. One way to ameliorate a processing window too narrow for a pump is dilution of catalyst using solvent. Such dilution complicates the process by requiring an accurate dilution step and requires accommodation of the solvent in the formulation.

Another class of organometallic salt is based on bismuth and is described in WO 2005/080464; US 2005/0137376; U.S. Pat. No. 5,491,174; U.S. Pat. No. 5,646,195; and U.S. Pat. No. 6,242,555, U.S. Pat. No. 6,825,238. However none of this prior art describes the use of an organometallic bismuth catalyst to produce open-celled, flexible polyurethane foams using natural oil polyols.

Accordingly it would be desirable to provide a flexible polyurethane foam having good properties, especially open cells, preferably generating low VOC's (Volatile Organic Compounds), that is made from at least one polyol based on a renewable resource and an organometallic catalyst providing wider processing window than is experienced using a common tin catalyst like tin octoate or dibutyltin dilaurate and same or faster curing than is experienced with tin catalysis. A processing window of at least about 25 percent of the catalyst level is desirable because it provides sufficient processing latitude, as explained previously.

Alternatively, it would be desirable to produce free-rise, slabstock or molded polyurethane foams, which are flexible, viscoelastic or a combination thereof, using polyols from renewable resources without the need for a tin catalyst. Independently, it would be desirable to produce shrinkage-free, slabstock or molded polyurethane foams, which are flexible, viscoelastic or a combination thereof, using polyols from renewable resources. Independently, it would be desirable to be able to reduce cell size of viscoelastic foams by adjusting the amount or type of catalysis.

### SUMMARY OF THE INVENTION

It has now been found that organobismuth catalysts are particularly useful in preparing flexible polyurethane foams made using at least 5 weight percent natural oil polyol.

In one aspect the invention is a process for producing a polyurethane product comprising steps of (a) supplying at least one polyisocyanate (b) supplying at least one polyol composition comprising at least about 5 weight percent based on total weight of polyols of at least one natural oil based polyol (b1), preferably having a hydroxyl number of at most about 300; and (c) exposing the polyisocyanate and the polyol composition to reaction conditions such that urethane bonds are formed, wherein reaction conditions include the presence of at least one bismuth catalyst.

In one embodiment, the present invention is a process for the production of a flexible polyurethane foams of density below 100 kg/m³ by reaction of a mixture of
(a) at least one organic polyisocyanate with
(b) a polyol composition comprising
   (b1) from 5 to 100 percent by weight of at least one polyol based on a renewable resource with a hydroxyl number below 300;
   (b2) optionally from 0 to 60 percent by weight of at least one polyol compound other than (b2) having a nominal starter functionality of 2 to 8 and a hydroxyl number from 15 to 200;
   (b3) Optionally from 1 to 50 percent by weight of an amine initiated polyol other than (b1) having a nominal starter functionality of 2 to 8 and an hydroxyl number from 15 to 200
(c) in the presence of at least one polyurethane catalyst, comprising at least one catalyst for the reaction of isocyanate and hydroxyl groups which is a bismuth compound;
(d) in the presence of 0.5 to 10 parts of water per hundred parts of polyol as blowing agent; and
(e) optionally using surfactants, additives and/or auxiliary agents known per se for the production of flexible polyurethane foams.

In another aspect the invention includes a viscoelastic polyurethane foam having a resilience of at most 25 percent as measured according to ASTM D3574 Test H, made using at least about 10 PPHP natural oil polyol and having an number average of cells per inch of at least than about 50 (19.7 per cm).

The invention includes flexible polyurethane foams produced by the process of the invention.

The polyol (b1) based on renewable resources is also referred to herein as a natural oil based polyol (NOBP). The polyol or polyols (b2) are preferably liquid at room temperature and have multiple active sites.

In some embodiments, polyol (b1) is optionally pre-reacted with at least a portion of the isocyanate and used as a prepolymer.

Surprisingly, flexible polyurethane foams produced by the process of the invention have at least one of wide processing window without substantial shrinkage, have fine cells, are of relatively low odor or exhibit lower emission of VOC's as compared with foams of the same formulations made using stannous octoate, adjusting the amount of catalyst as is known within the skill in the art. This advantage is achieved by including in the polyol (b) composition a natural oil based polyol (b1) and using a bismuth compound as a catalyst to make the polyurethane.

### DETAILED DESCRIPTION OF THE INVENTION

Definitions:

The term “resilience” or “resiliency” is used to refer to the quality of a foam perceived as springiness. It is measured according to the procedures of ASTM D3574 Test H. This ball rebound test measures the height a dropped steel ball of known weight rebounds from the surface of the foam when dropped under specified conditions and expresses the result as a percentage of the original drop height.

The term “ball rebound” is used herein to refer to result of test procedure of ASTM D3574-Test H as previously described.

The term “density” is used herein to refer to weight per unit volume of a foam. Density is determined according to the procedures of ASTM D357401, Test A.

The term “CS 75% Parallel-CT” stands for compression set test measured at the 75 percent compressive deformation level and parallel to the rise direction in the foam. This test is used herein to correlate in-service loss of cushion thickness and changes in foam hardness. The compression set is determined according to the procedures of ASTM D 3574-95, Test I. and is measured as percentage of original thickness of the sample. Similarly, “CS 90% Parallel-CT” refers to the same measurement as above (compression set), but this time measured at 90 percent compressive deformation level of the sample, parallel to the rise direction in the foam.

The term “air flow” refers to the volume of air which passes through a 1.0 inch (2.54 cm) thick 2 inch×2 inch (5.08 cm) square section of foam at 125 Pa (0.018 psi) of pressure. Units are expressed in cubic decimeters per second and converted to standard cubic feet per minute. A representative commercial unit for measuring air flow is manufactured by TexTest AG of Zurich, Switzerland and identified as TexTest Fx3300. This measurement follows ASTM D 3574 Test G.

The term “NCO Index” means isocyanate index, as that term is commonly used in the polyurethane art. As used herein as the equivalents of isocyanate, divided by the total equivalents of isocyanate-reactive hydrogen containing materials, multiplied by 100. Considered in another way, it is the ratio of isocyanate-groups over isocyanate-reactive hydrogen atoms present in a formulation, given as a percentage. Thus, the isocyanate index expresses the percentage of isocyanate actually used in a formulation with respect to the amount of isocyanate theoretically required for reacting with the amount of isocyanate-reactive hydrogen used in a formulation.

As used herein, the term “viscoelasticity” is the time dependent response of a material to an applied constant load (stress) due to the co-existence of elastic (solid) and viscous (liquid) characteristics in the material. This is best observed in creep experiments (akin to the process of a person lying on the bed at night—constant load) in which the rates of deformation varies with time, starting out with an initial instantaneous deformation value (elastic component) and then going through several fast deformation regimes with time (viscoelastic components) and finally reaching a steady strain rate value (liquid component) or zero strain rate value (highly cross linked network materials). In dynamic mechanical characterization, the level of viscoelasticity is proportional to the damping coefficient measured by the tan delta of the material. The tan delta is the ratio of the viscous dissipative loss modulus G″ to the elastic storage modulus G′. High tan delta values imply that there is a high viscous component in the material behavior and hence a strong damping to any perturbation will be observed.

The term “viscoelastic foam” is intended to designate those foams having a resilience of at most 25 percent, as measured according to ASTM D3574 Test H. Resilient foams are those having a resilience of at least 25 percent, and high resilience foams have a resilience above 50 percent. Viscoelastic (VE) foams exhibit a time-delayed and rate-dependent response to an applied stress. In addition to low resiliency they have slow recovery when compressed. In a polyurethane foam, these properties are often associated with the glass transition temperature (T_{g}) of the polyurethane. Viscoelasticity is often manifested when the polymer has a Tg at or near the use temperature, which is room temperature for many applications. Viscoelastic or “memory” foams have a number of very desirable performance characteristics. Viscoelastic foam tends to be low resilience, shape or body conforming, and able to dampen both sound and vibration or shock. A general teaching about viscoelastic foams can be found in US 2005/038133.

As used herein the term “flexible” foam means a foam which recovers upon release from compressive or stretching forces, preferably can be compressed or elongated more than 10% without exceeding its elastic limit. Preferably the foams are sufficiently resilient to compress without damage to the foam structure when a load is applied to the foam. Preferably, a flexible foam will also bounce or spring back to its original size and shape after the load is removed, even after several repetitions of applying and removing a load. This is in contrast to rigid foams that will either not compress without damage to the foam structure when a load is applied to the foam or will not bounce back to their original size and shape after the load has been removed (especially if the load is applied and removed more than once).

As used herein, the term “open celled” means that the individual cells of a foam are interconnected by open channels. Cellular materials, of which foams are an example, are generally defined as two-phase gas-solid systems wherein the solid phase exists as a continuous matrix and the gas-phase occupies pockets dispersed throughout the matrix. The pockets, also known as cells or voids, in one configuration are discrete such that the gas phase within each cell is independent of that present in other cells. Cellular materials having discrete cells are denoted closed-cell foams. Alternatively, in another configuration, the cells are partially or largely interconnected, in which case the system is termed an open-celled foam. Open cells can be measured by airflow. Preferably foams have an airflow of at least 0.6 cfm (cubic foot per minute), more preferably higher than 0.8 cfm and even more preferably higher than 1.0 cfm (0.28317, 0.37756, 0.47195 liters/sec, respectively).

As used herein, the term “shrinkage free” as applied to a foam herein means that the foam is substantially the same size after its initial rising and solidifying as it is when it as cooled to room temperature. For a shrinkage free foam, the sum of shrinkage in the three dimensions is less than 8 percent, preferably less than 6 percent, more preferably less than 4 percent.

As used herein, “polyol” refers to an organic molecule having an average of greater than 1.0 active hydrogen groups, preferably hydroxyl groups per molecule. It optionally includes other functionalities, that is, other types of functional groups. Preferred among such compounds are materials having at least two hydroxyls, primary or secondary, or at least two amines, primary or secondary, carboxylic acid, or thiol groups per molecule. Compounds having at least two hydroxyl groups or at least two amine groups per molecule are especially preferred due to their desirable reactivity with polyisocyanates, with at least two hydroxyl groups most preferred.

As used herein the term “conventional polyol” or “additional polyol” is used to designate a polyol of other than vegetable or animal origin, preferably of petroleum origin, within the skill in the art for use in polyurethanes or other polymers. The term “conventional polyether polyol” is used for a polyol formed from at least one alkylene oxide, preferably ethylene oxide, propylene oxide or a combination thereof, and not having a part of the molecule derived from a vegetable or animal oil, a polyol of the type commonly used in making polyurethane foams. A polyether polyol can be prepared by known methods such as by alkoxylation of suitable starter molecules. Such a method generally involves reacting an initiator such as, water, ethylene glycol, or propylene glycol, with an alkylene oxide in the presence of a catalyst such as KOH or DMC. Ethylene oxide, propylene oxide, butylene oxide, or a combination of these oxides can be particularly useful for the alkoxylation reaction. A polyether polyol, for instance polyoxyethylene polyol can contain alkyl substituents. The process for producing polyether polyols can involve a heterogeneous feed of a mixture of alkylene oxides, a sequential feed of pure or nearly pure alkylene oxide polyols to produce a polyol with blocks of single components, or a polyol which is capped with, for example, ethylene oxide or propylene oxide. These types of polyols preferably having an unsaturation below 0.1 mequiv/g are all known and used in polyurethane chemistry. In addition to polyether polyols, conventional polyols include, for instance, polyester polyols, polycaprolactone polyols or combinations thereof.

The term “natural oil polyol” (hereinafter NOP) is used herein to refer to compounds having hydroxyl groups which compounds are isolated from, derived from or manufactured from natural oils, including animal and vegetable oils, preferably vegetable oils. Examples of vegetable and animal oils that are optionally used include, but are not limited to, soybean oil, safflower oil, linseed oil, corn oil, sunflower oil, olive oil, canola oil, sesame oil, cottonseed oil, palm oil, rapeseed oil, tung oil, fish oil, or a blend of any of these oils. Alternatively, any partially hydrogenated or epoxidized natural oil or genetically modified natural oil can be used to obtain the desired hydroxyl content. Examples of such oils include, but are not limited to, high oleic safflower oil, high oleic soybean oil, high oleic peanut oil, high oleic sunflower oil (such as NuSun sunflower oil), high oleic canola oil, and high erucic rapeseed oil (such as Crumbe oil). Natural oil polyols are well within the knowledge of those skilled in the art, for instance as disclosed in Colvin et al., UTECH Asia, Low Cost Polvols from Natural Oils, Paper 36, 1995 and “Renewable raw materials—an important basis for urethane chemistry:” Urethane Technology: vol. 14, No. 2, April/May 1997, Crain Communications 1997, WO 01/04225; WO 040/96882; WO 040/96883; U.S. Pat. No. 6,686,435; U.S. Pat. No. 6,433,121; U.S. Pat. No. 4,508,853; U.S. Pat. No. 6,107,403; U.S. Pat. No. Pregrant publications 20060041157, and 20040242910.

The term “natural oil based polyol” is used herein to refer to NOP compounds which are derived from natural oils. For instance, natural oils or isolates therefrom are reacted with compounds ranging from air or oxygen to organic compounds including amines and alcohols. Frequently, unsaturation in the natural oil is converted to hydroxyl groups or to a group which can subsequently be reacted with a compound that has hydroxyl groups such that a polyol is obtained. Such reactions within the skill in the art and are discussed in the references in the preceding paragraph.

The term “prepolymer” is used to designate a reaction product of monomers which has remaining reactive functional groups to react with additional monomers to form a polymer.

The term “natural oil based prepolymer” or “natural oil prepolymer” is used herein to describe prepolymers comprising at least one natural oil polyol reacted with at least one monomer reactive therewith in an amount in excess of that amount necessary to form a polymer such that the resulting prepolymer has functional groups remaining that are reactive with hydroxyl groups. For instances, when at least one isocyanate is the reactive monomer, isocyanate prepolymers of natural oil polyols are formed. Forming and using such prepolymers are within the skill in the art such as disclosed by WO 2006/047434 which is incorporated herein by reference to the fullest extent permitted by law.

The term “renewable resource” is used herein to designate animal and plant fats or oils as distinguished from, for instance, petroleum oils and derivatives.

The term “hydroxyl number” indicates the concentration of hydroxyl moieties in a composition of polymers, particularly polyols. A hydroxyl number represents mg KOH/g of polyol. A hydroxyl number is determined by acetylation with pyridine and acetic anhydride in which the result is obtained as the difference between two titrations with KOH solution. A hydroxyl number is, thus, defined as the weight of KOH in milligrams that will neutralize the acetic anhydride capable of combining by acetylation with 1 gram of a polyol. A higher hydroxyl number indicates a higher concentration of hydroxyl moieties within a composition. Descriptions of determinations for the hydroxyl number for a composition can be found in texts well-known in the art, for example in Woods, G., The ICI Polyurethanes Book—2nd ed. (ICI Polyurethanes, Netherlands, 1990).

The term “primary hydroxyl group” means a hydroxyl group (—OH) on a carbon atom which has only one other carbon atom attached to it, (preferably which has only hydrogen atoms attached thereto) (—CH₂—OH). A secondary hydroxyl group is on a carbon atom having 2 carbon atoms attached thereto.

The term “functionality” particularly “polyol functionality” is used herein to refer to the number of hydroxyl groups in a polyol.

The term “nominal starter functionality” is used herein to designate the number average functionality (number of hydroxyl groups per molecule) of the polyol or polyol composition on the assumption that this is the number average functionality (number of active hydrogen atoms per molecule) of the raw materials used in its synthesis, typically initiator(s) used in the in the preparation of the polyol(s). The word “average” refers to number average unless indicated otherwise. If a mixed initiator is used, then the nominal functionality of the polyol is the number averaged functionality of the mixed initiator.

The term “VOC” as applied to a polyurethane foam that has been heat, especially flame, bonded, means amounts of volatile organic compounds are released when foam is heated. VOC is measured according to the procedures of VDA 278 (Thermodesorption test) or DIN EN 13419-1 (Chamber test) in milligrams of VOC's. Desirably the amounts are minimal.

All percentages, preferred amounts or measurements, ranges and endpoints thereof herein are inclusive, that is, “less than about 10” includes about 10. “At least” is, thus, equivalent to “greater than or equal to,” and “at most” is, thus, equivalent “to less than or equal to.” Numbers herein have no more precision than stated. Thus, “115” includes at least from 114.5 to 115.49. Furthermore, all lists are inclusive of combinations of two or more members of the list. All ranges from a parameter described as “at least,” “greater than,” “greater than or equal to” or similarly, to a parameter described as “at most,” “up to,” “less than,” “less than or equal to” or similarly are preferred ranges regardless of the relative degree of preference indicated for each parameter. Thus a range that has an advantageous lower limit combined with a most preferred upper limit is preferred for the practice of this invention. All amounts, ratios, proportions and other measurements are by weight unless stated otherwise. All percentages refer to weight percent based on total composition according to the practice of the invention unless stated otherwise. Except in the examples, or where otherwise indicated, all numbers expressing quantities, percentages, OH numbers, functionalities and so forth in the specification are to be understood as being modified in all instances by the term “about.” Unless stated otherwise or recognized by those skilled in the art as otherwise impossible, steps of processes described herein are optionally carried out in sequences different from the sequence in which the steps are discussed herein. Furthermore, steps optionally occur separately, simultaneously or with overlap in timing. For instance, such steps as heating and admixing are often separate, simultaneous, or partially overlapping in time in the art. Unless stated otherwise, when an element, material, or step capable of causing undesirable effects is present in amounts or in a form such that it does not cause the effect to an unacceptable degree it is considered substantially absent for the practice of this invention. Furthermore, the terms “unacceptable” and “unacceptably” are used to refer to deviation from that which can be commercially useful, otherwise useful in a given situation, or outside predetermined limits, which limits vary with specific situations and applications and can be set by predetermination, such as performance specifications. Those skilled in the art recognize that acceptable limits vary with equipment, conditions, applications, and other variables but can be determined without undue experimentation in each situation where they are applicable. In some instances, variation or deviation in one parameter can be acceptable to achieve another desirable end.

The term “comprising”, is synonymous with “including,” “containing,” or “characterized by,” is inclusive or open-ended and does not exclude additional, unrecited elements, material, or steps. The term “consisting essentially of indicates that in addition to specified elements, materials, or steps; elements, unrecited materials or steps are optionally present in amounts that do not unacceptably materially affect at least one basic and novel characteristic of the subject matter. The term “consisting of” indicates that only stated elements, materials or steps are present.

(a) Organic Polyisocyanate:

An organic polyisocyanate, referred to herein as an isocyanate, is any organic compound or composition having an average of more than 1, preferably an average of at least about 1.8, isocyanate groups per organic molecule. Isocyanates which are optionally used in the present invention include aliphatic, cycloaliphatic, arylaliphatic and aromatic isocyanates. Aromatic isocyanates are preferred.

Examples of suitable aromatic isocyanates include the 4,4′-, 2,4′ and 2,2′-isomers of diphenylmethane diisocyanate (MDI), blends thereof and polymeric and monomeric MDI blends, toluene-2,4- and 2,6-diisocyanates (TDI), m- and p-phenylenediisocyanate, chlorophenylene-2,4-diisocyanate, diphenylene-4,4′-diisocyanate, 4,4′-diisocyanate-3,3′-dimehtyldiphenyl, 3-methyldiphenyl-methane-4,4′-diisocyanate and diphenyletherdiisocyanate and 2,4,6-triisocyanatotoluene and 2,4,4′-triisocyanatodiphenylether.

Mixtures of isocyanates are optionally used, such as the commercially available mixtures of 2,4- and 2,6-isomers of toluene diisocyanates. A crude polyisocyanate is optionally used in the practice of this invention, such as crude toluene diisocyanate obtained by the phosgenation of a mixture of toluene diamine or the crude diphenylmethane diisocyanate obtained by the phosgenation of crude methylene diphenylamine. TDI/MDI blends are optionally used. MDI or TDI based prepolymers are optionally used, made either with polyol (b1), polyol (b2) or any other polyol described herein. Isocyanate-terminated prepolymers are prepared by reacting an excess of polyisocyanate with at least one polyol, including aminated polyols or imines/enamines thereof, or polyamines.

Examples of aliphatic polyisocyanates include ethylene diisocyanate, 1,6-hexamethylene diisocyanate, isophorone diisocyanate, cyclohexane 1,4-diisocyanate, 4,4′-dicyclohexylmethane diisocyanate, saturated analogues of the above mentioned aromatic isocyanates and mixtures thereof.

For the production of flexible foams, the preferred polyisocyanates are the toluene-2,4- and 2,6-diisocyanates or MDI or combinations of TDI/MDI or prepolymers made therefrom.

The amount of polyisocyanate used in making a flexible foam is commonly expressed in terms of isocyanate index, that is, 100 times the ratio of NCO groups to reactive hydrogens-contained in the reaction mixture. In the production of conventional slabstock foam, the isocyanate index often ranges from about 75-140, especially from about 80 to 115. In molded and high resiliency slabstock foam, the isocyanate index often ranges from about 50 to about 150, especially from about 75 to about 110.

Thus, in the practice of the invention the isocyanate index is advantageously at least about 60, more advantageously at least about 70, preferably at least about 80, more preferably at least about 90, and independently advantageously at most about 150, more advantageously at most about 130, preferably at most about 120, more preferably at most about 115, most preferably at most about 110.

(b) Polyol Composition

In the practice of the invention, at least one polyol composition is used, which composition comprises at least one polyol (b1), and, optionally, at least 1 polyol designated (b2), at least one polyol designated (b3) or a combination thereof.

(b1) At Least One Polyol Based on a Renewable Resource, that is NOBP

Polyols (b1) are polyols based on or derived from renewable resources such as natural and/or genetically modified (GMO) plant vegetable seed oils and/or animal source fats. Such oils and/or fats are generally comprised of triglycerides, that is, fatty acids linked together with glycerol. Preferred are vegetable oils that have at least about 70 percent unsaturated fatty acids in the triglyceride. Preferably the natural product contains at least about 85 percent by weight unsaturated fatty acids. Examples of preferred vegetable oils include, for example, those from castor, soybean, olive, peanut, rapeseed, corn, sesame, cotton, canola, safflower, linseed, palm, sunflower seed oils, or a combination thereof. Examples of animal products include lard, beef tallow, fish oils and mixtures thereof. A combination of vegetable and animal based oils/fats is optionally used. The iodine value of these natural oils range from about 40 to 240. Preferably polyols (b1) are derived from soybean and/or castor and/or canola oils.

For use in the production of flexible polyurethane foam it is generally desirable to modify the natural materials to give the material isocyanate reactive groups or to increase the number of isocyanate reactive groups on the material. Preferably such reactive groups are a hydroxyl group. Several chemistries can be used to prepare the polyols of (b1). Such modifications of a renewable resource include, for example, epoxidation, as described in U.S. Pat. No. 6,107,433 or in U.S. Pat. No. 6,121,398; hydroxylation, such as described in WO 2003/029182; esterification such as described in U.S. Pat. Nos. 6,897,283; 6,962,636 or 6,979,477; hydroformylation as described in WO 2004/096744; grafting such as described in U.S. Pat. No. 4,640,801; or alkoxylation as described in U.S. Pat. No. 4,534,907 or in WO 2004/020497. These cited references for modifying the natural products are incorporated herein by reference to the fullest extent permitted by law. Other polyols suitable for practice of the invention include those disclosed in such references as Grosch, G. H. et. al., WO0014045(A1) (Mar. 16, 2000); David M. Casper, US20060041155(A1), Aug. 23, 2004; David M. Casper and Trevor Newbold, US20060041156(A1); Ashvin Shah and Tilak Shah, WO 0104225(A1), (Jul. 12, 2000), Ron Herrington and Jeffrey Malsam, US20050070620(A1), (Jun. 25, 2004). Dwight E. Peerman and Edgar R. Rogier, EP106491 (Sep. 6, 1983); U.S. Pat. No. 4,496,487 (Sep. 7, 1982); U.S. Pat. No. 4,423,162 (Dec. 27, 1983); and U.S. Pat. No. 4,543,369 (Oct. 26, 1984); Zoran S. Petrovic et al. all of which are incorporated herein by reference to the fullest extent permitted by law. After the production of such polyols by modification of the natural oils, the modified products are optionally further alkoxylated. The use of ethylene oxide (EO) or mixtures of EO with other oxides, introduce hydrophilic moieties into the polyol. In one embodiment, the modified product undergoes alkoxylation with sufficient EO to produce a polyol (b1) with preferably at least about 10, more preferably at least about 20 to preferably at most about 60, more preferably at most about 40 weight percent EO.

In another embodiment, preferred polyols (b1) are those disclosed in PCT Publications WO 2004/096882 and 2004/096883, and copending PCT Publication WO2006/118995 entitled “Polyester Polyols Containing Secondary Alcohol Groups and Their Use in Making Polyurethanes Such as Flexible Polyurethane Foams,” the disclosures of which represent skill in the art and are incorporated herein by reference to the fullest extent permitted by law. Polyols disclosed in WO 04/096882 and WO 04/096883 are most preferred. These are the reaction products of initiators having active hydrogen such as a polyol or polyamine, amino alcohol or mixture thereof with a vegetable oil based monomer prepared by such processes as hydroformylation of unsaturated fatty acids or esters, followed by hydrogenation of at least a portion of the resulting formyl groups. Such a polyol is referred to hereinafter as “initiated fatty acid polyester alcohol.” Among these, more preferred polyols include those initiated with alkoxylated, preferably ethoxylated, polyhydroxyl compounds, preferably glycerin, sucrose, or combinations thereof, and having a molecular weight of advantageously at least about 400, more preferably at least about 600 and preferably at most about 1000, more preferably at most about 800. In an alternative embodiment, the polyols taught in WO2006/118995, referred to herein as “initiated secondary hydroxyl fatty acid copolyesters” are most preferred. These are the reaction products of initiators such as those used in making the initiated fatty acid polyester alcohols with a vegetable oil based monomer or oligomer which naturally has secondary hydroxyl groups, such as ricinoleic acid or into which secondary hydroxyl groups have been introduced by such processes as reacting water across a double bond for instance as taught in such references as U.S. Pat. No. 6,018,063 and by Isbell et al., J. Amer. Oil Chem. Soc., 71 (4) 379 (1994); reacting an unsaturated fatty acid or ester with formic acid as taught for instance in U.S. Pat. No. 2,759,953, oxidation of fatty acids or esters for instance as taught by John et al., J. Appl. Polym. Sci. 86, 3097 (2002) and Swern et al., JACS, 67, 1134 (1945), by epoxidation and ring opening and the like. Thus, polyol or polyol combination (b1) optionally has primary, secondary or a combination thereof hydroxyl groups. Both types of most preferred polyols are favored, in part, because either can optionally include polyols (b1) with both hydrophobic and hydrophilic moieties. The hydrophobic moiety is provided by the natural oils since those contain C4 to C24 saturated and/or unsaturated chain lengths, preferably C4 to C18 chain lengths, while the hydrophilic moiety is obtained by the use of hydrophilic polyol chains present on the initiator, such as those containing high levels of ethylene oxide.

Preferably the initiator is selected from the group consisting of neopentylglycol; 1,2-propylene glycol; trimethylolpropane; pentaerythritol; sorbitol; sucrose; glycerol; diethanolamine; alkanediols such as 1,6-hexanediol, 1,4-butanediol; 1,4-cyclohexane diol; 2,5-hexanediol; ethylene glycol; diethylene glycol, triethylene glycol; bis-3-aminopropyl methylamine; ethylene diamine; diethylene triamine; 9(1)-hydroxymethyloctadecanol, 1,4-bishydroxymethylcyclohexane; 8,8-bis(hydroxymethyl)tricyclo[5,2,1,0^{2,6}]decene; Dimerol alcohol; hydrogenated bisphenol; 9,9(10,10)-bishydroxymethyloctadecanol; 1,2,6-hexanetriol and combination thereof. More preferably the initiator is selected from the group consisting of glycerol; ethylene glycol; 1,2-propylene glycol; trimethylolpropane; ethylene diamine; pentaerythritol; diethylene triamine; sorbitol; sucrose; or any of the aforementioned where at least one of the alcohol or amine groups present therein has been reacted with ethylene oxide, propylene oxide or mixture thereof; and combination thereof. Most preferably the initiator is glycerol, trimethylopropane, pentaerythritol, sucrose, sorbitol, and/or mixture thereof.

In one preferred embodiment, such initiators are alkoxylated with ethylene oxide or a mixture of ethylene and at least one other alkylene oxide to give an alkoxylated initiator with a molecular weight of 200 to 6000, especially from 400 to 2000. Preferably the alkoxylated initiator has a molecular weight from 500 to 1000. In another embodiment, polyol (b1) contains a high EO (ethylene oxide) based moiety. In one embodiment, polyol (b1) preferably contains at least about 10 weight percent ethylene oxide, that is, has at least about 10 weight percent molecular structures derived from ethylene oxide (EO). More preferably polyol (b1) is prepared from at least about 15, most preferably at least about 20 weight percent EO. Independently, preferably polyol (b1) contains at most about 60, more preferably at most about 50, most preferably at most about 40 weight percent ethylene oxide.

Preferably, the functionality of polyol (b1), or blend of such polyols, is at least about 1.5, more preferably at least about 1.8, most preferably at least about 2.0 and independently preferably at most about 6, more preferably at most about 5, most preferably the functionality is at most about 4. The hydroxyl number of polyol (b1), or blend of such polyols, is preferably at most about 300 mg KOH/g, more preferably at most about 200, most preferably at most about 100 mg KOH/g.

Polyol (b1) or a blend thereof constitutes up to 100 weight percent of the polyol formulation or composition. Polyol (b1) constitutes advantageously at least about 5, more advantageously at least about 10, preferably at least about 25, more preferably at least about 35, most preferably at least about 50 weight percent of the total weight of the polyol components present up to about 100 weight percent, preferably with a content of at least 50 percent renewable resources (that is, coming from the seed oil and/or other plants or animals). Alternatively, polyol (b1) advantageously constitutes at most about 95, more advantageously at most about 90, preferably at most about 85, more preferably at most about 80, most preferably at most about 75 weight percent of the total weight of the polyol.

Polyol (b1) is optionally any combination of two or more polyols described as (b1). When more than one (b1) polyol is used, two or more are optionally of the same type or, in another embodiment, are of different types, for instance as disclosed in U.S. Provisional Application Ser. No. 60/963,704, filed Aug. 6, 2007, and titled “Polyol blends for use in making polymers.” Combinations often are useful to maximize the level of seed oil in the foam formulation, or to optimize foam processing and/or specific foam characteristics, such as resistance to humid aging. In this embodiment, (b1) comprises at least two different natural oil polyols (b1) wherein the differences are in at least one of (a) processes by which they are made, preferably wherein at least two natural oil polyols are sufficiently different to result in improved physical or processing properties, satisfactory properties at a higher level of renewable resources. More preferably at least about 2 weight percent higher, or when using a larger amount of combined natural oil polyols in a resulting polymeric product or a combination thereof, all as compared with essentially the same end product produced by essentially the same process but using one of the natural oil polyols alone in an amount equal to that of the combination of natural oil polyols. Independently preferably, the processes differ by at least one of reaction temperature, reaction time, reaction pressure or a combination thereof, preferably by more than one of reaction temperature, reaction time, reaction pressure, catalyst, at least, more preferably by at least one unit operation, or a combination thereof, more preferably wherein at least the first process involves at least one unit operation of hydroformylation, epoxidation, alkoxylation, esterification, transesterification, alcoholysis, oxidation, ring opening using a natural oil or derivative thereof while the second process does not involve at least one of the listed unit operations used in preparing the first polyol or involves at least one additional unit operation or, a combination of both, most preferably wherein at least two natural oil polyols represent different members of the group consisting of triethanolamine alcoholyzed peroxy acid hydroxylate, epoxidized vegetable oil at least partially ring opened to produce a secondary hydroxyl group on a main vegetable oil chain, hydroformylated vegetable oil where the formyl groups have been at least partially converted to hydroxymethyl groups; air blown vegetable oil (not alkoxylated or further treated), alkoxylated air blown vegetable oil, transesterified air blown oil; fatty acid alcohol alkoxylates; transesterified vegetable oil, alkoxylated vegetable oil; alkoxylated polyester polyol, polyester polyol, polyetherpolyester polyol, initiated fatty acid polyester alcohol; epoxy ring-opening oligomer, and natural polyol. The two polyols independently preferably differ by at least one of the following: percentage of hydroxyl groups that are primary as compared to secondary; hydroxyl functionality; molecular weight; hydrophilicity (level of ethylene oxide); or natural oil raw material. More preferably (a) at least one of the different natural oil polyols has at least about 50, percent of its hydroxyl groups as primary while at least one different natural oil polyol has at least about 51, percent of its hydroxyl groups as secondary; (b) the polyols differ in hydroxyl functionality by at least about 10 percent; (c) have molecular weights differing by at least about 10 percent; (d) differ in hydrophilicity, by at least about 10 percent in level of ethylene oxide incorporated into the polyol molecules; (e) differ in originating from different natural oil raw materials, (f) differ in having a difference in fatty acid distribution as reflected in at least about a 10 weight percent difference in the level of any fatty acid or ester; or a combination thereof. Most preferably at least one of the natural oil polyols is at least one initiated fatty acid polyester alcohol. Independently, most preferably at least one natural oil polyol comprises at least one natural oil polyol which has been oxidized or epoxidized in some stage of its preparation. In a preferred embodiment at least one of the different natural oil polyols is a initiated fatty acid polyester alcohol, while at least one different natural oil polyol has be oxidized or epoxidized.

The viscosity of the polyol (b1) measured at 25° C. is advantageously less than about 10,000 mPa·s. Preferably the viscosity of polyol (b1) at 25° C. is less than about 8,000 mPa·s.

(b2) Optional Additional Polyol

Suitable polyols referred to as polyol (b2) of the present invention include any polyol or combination thereof not of animal or vegetable origin, defined as “conventional polyols” or “additional polyols” previously herein. Furthermore, (b2) is different from (b3), thus is not autocatalytic as defined hereinafter for (b3). Such conventional polyols are well known in the art and include those described herein and any other commercially available polyol and/or SAN, PIPA or PHD copolymer polyols. Such polyols are described in “Polyurethane Handbook”, by G. Oertel, Hanser publishers. Mixtures of one or more such polyols, one or more copolymer polyols or a combination thereof are optionally used to produce polyurethane products according to the practice of the present invention.

Representative polyols include polyether polyols, polyester polyols, polyhydroxy-terminated acetal resins, hydroxyl-terminated amines and polyamines. Examples of these and other suitable isocyanate-reactive materials are described more fully in U.S. Pat. No. 4,394,491. Alternative polyols that are optionally used include polyalkylene carbonate-based polyols and polyphosphate-based polyols. Preferred are polyols prepared by adding an alkylene oxide, such as ethylene oxide, propylene oxide, butylene oxide or a combination thereof, to an initiator having from 2 to 8, preferably 2 to 6 active hydrogen atoms. Catalysis for this polymerization can be either anionic or cationic, with catalysts such as KOH, CsOH, boron trifluoride, or a double cyanide complex (DMC) catalyst such as zinc hexacyanocobaltate or quaternary phosphazenium compound.

Examples of suitable initiator molecules are water, organic dicarboxylic acids, such as succinic acid, adipic acid, phthalic acid and terephthalic acid; and polyhydric, in particular dihydric to octohydric alcohols or dialkylene glycols.

Exemplary polyol initiators include, for example, ethanediol, 1,2- and 1,3-propanediol, diethylene glycol, dipropylene glycol, 1,4-butanediol, 1,6-hexanediol, glycerol, pentaerythritol, sorbitol, sucrose, neopentylglycol; 1,2-propylene glycol; trimethylolpropane glycerol; 1,6-hexanediol; 2,5-hexanediol; 1,4-butanediol; 1,4-cyclohexane diol; ethylene glycol; diethylene glycol; triethylene glycol; 9(1)-hydroxymethyloctadecanol, 1,4-bishydroxymethylcyclohexane; 8,8-bis(hydroxymethyl)tricyclo[5,2,1,0^{2,6}]decene; dimerol alcohol (36 carbon diol available from Henkel Corporation); hydrogenated bisphenol; 9,9(10,10)-bishydroxymethyloctadecanol; 1,2,6-hexanetriol; and combination thereof.

Of particular interest are poly(propylene oxide) homopolymers, random copolymers of propylene oxide and ethylene oxide in which the poly(ethylene oxide) content is, for example, from about 1 to about 30 percent by weight, ethylene oxide-capped poly(propylene oxide) polymers and ethylene oxide-capped random copolymers of propylene oxide and ethylene oxide. For slabstock foam applications, such polyethers preferably contain at least about 2 and independently preferably at most about 8, more preferably at most about 6, and most preferably at most about 4, predominately (greater than 50 percent) secondary (but also some primary) hydroxyl groups per molecule and have an equivalent weight per hydroxyl group of from preferably at least about 400, more preferably at least about 800 to preferably at most about 3000, more preferably at most about 1750. For high resiliency slabstock and molded foam applications, that is, having ball rebound of at least 40 percent, such polyethers preferably contain at least about 2 and independently preferably at most about 6, more preferably at most about 5, and most preferably at most about 5 predominately primary hydroxyl groups per molecule and have an equivalent weight per hydroxyl group of preferably from at least about 1000, more preferably at least about 1200 to preferably at most about 3000, more preferably at most about 2000. When blends of polyols are used, the nominal average functionality (number of hydroxyl groups per molecule) preferably are in the ranges specified above.

For viscoelastic foams shorter chain polyols with hydroxyl numbers preferably above about 150 are optionally used alone or in combination with a lower hydroxyl (b1).

The polyether polyols optionally contain low terminal unsaturation (for example, less than about 0.02 meq/g or less than about 0.01 meq/g), such as those made using so-called double metal cyanide (DMC) catalysts, as described for example in U.S. Pat. Nos. 3,278,457, 3,278,458, 3,278,459, 3,404,109, 3,427,256, 3,427,334, 3,427,335, 5,470,813 and 5,627,120. Polyester polyols often contain about 2 hydroxyl groups per molecule and have an equivalent weight per hydroxyl group of about 400-1500. Polymer polyols of various types are optionally used as well. Polymer polyols include dispersions of polymer particles, such as polyurea, polyurethane-urea, polystyrene, polyacrylonitrile and polystyrene-co-acrylonitrile polymer particles in a polyol, typically a polyether polyol. Suitable polymer polyols include all within the skill in the art, for instance those described in U.S. Pat. Nos. 4,581,418 and 4,574,137.

Overall polyols (b2) preferably have at least about 2 and independently preferably at most about 8, more preferably at most about 6, and most preferably at most about 4, primary or secondary or a combination thereof hydroxyl groups per molecule and have a hydroxyl number of preferably at least about 15, more preferably at least about 32, most preferably at least about 45, optionally and independently to preferably at most about 200, more preferably at most about 180, most preferably at most about 170. The viscosity of the polyol (b2) measured at 25° C. is advantageously less than about 10,000 mPa·s, preferably less than about 8,000. While use of polyol (b2) or a combination thereof is optional in the practice of the invention, thus can be present in an amount of 0 weight percent, it is preferably present in an amount of at least about 5, more preferably at least about 10, most preferably at least about 20; optionally to preferably at most about 80, more preferably at most about 60, most preferably at most about 50 weight percent based on total polyol weight.

(b3) Amine Initiated or Autocatalytic Polyol

Polyol (b3) is at least one polyol which has autocatalytic activity that is capable of replacing a portion or all of the amine catalyst, organometallic catalyst or combination thereof generally used in the production of polyurethane foams. Autocatalytic polyols are those made from an initiator containing a tertiary amine, polyols containing a tertiary amine group in the polyol chain or a polyol partially capped with a tertiary amine group. In its known applications, (b3) is added to replace at least about 10, more preferably at least about 20, most preferably at least about 30 percent by weight of amine catalyst while maintaining the same reaction profile. Such autocatalytic polyols are optionally used to replace at least 50 percent by weight of the amine catalyst while maintaining the same reaction profile. Alternatively, such autocatalytic polyols are optionally added to enhance the demold time.

Such autocatalytic polyols are well within the skill in the art and are disclosed in such references as EP 539,819, in U.S. Pat. No. 5,672,636; and in WO 01/58,976, the disclosure of which is incorporated herein by reference, which references disclose amine-initiated polyols; and U.S. Pat. Nos. 3,428,708; 5,482,979; 4,934,579 and 5,476,969, which disclose polyols containing tertiary amino groups. Both types of polyols and all types within the skill in the art, particularly as disclosed in the cited references are among those autocatalytic for polyurethane reactions.

In one preferred embodiment, the autocatalytic polyol has a molecular weight of from about 1000 to about 12,000 and is prepared by alkoxylation, preferably using ethylene oxide (EO), propylene oxide (PO) or a mixture thereof, of at least one initiator molecule of the formula

HₘA-(CH₂)ₙ—N(R)—(CH₂)ₚ-AHₘ Formula (I)

wherein n and p are independently integers from 2 to 6; A, at each occurrence is independently, oxygen, nitrogen, sulfur or hydrogen, with the proviso that only one of A can be hydrogen at one time; R is a C₁ to C₃ alkyl group; and m is equal to 0 when A is hydrogen, is 1 when A is oxygen and is 2 when A is nitrogen; or

H₂N—(CH₂)ₘ—N—(R)—H Formula (II)

where m is an integer from 2 to 12; and R is a C₁ to C₃ alkyl group.

Preferred initiators for the production of such autocatalytic polyols include, 3,3′-diamino-N-methyldipropylamine, 2,2′-diamino-N-methyldiethylamine, 2,3-diamino-N-methyl-ethyl-propylamine N-methyl-1,2-ethanediamine and N-methyl-1,3-propanediamine. Other initiators include linear and cyclic compounds containing an amine. Exemplary polyamine initiators include ethylene diamine, neopentyldiamine, 1,6-diaminohexane; bisaminomethyltricyclodecane; bisaminocyclohexane; diethylene triamine; bis-3-aminopropyl methylamine; triethylene tetramine various isomers of toluene diamine; diphenylmethane diamine; N-methyl-1,2-ethanediamine, N-Methyl-1,3-propanediamine, N,N-dimethyl-1,3-diaminopropane, N,N-dimethylethanolamine, 3,3′-diamino-N-methyldipropylamine, N,N-dimethyldipropylenetriamine, aminopropyl-imidazole. Exemplary aminoalcohols include ethanolamine, diethanolamine, and triethanolamine. Other useful initiators that are alternatively used include polyols, polyamines or aminoalcohols described in U.S. Pat. Nos. 4,216,344; 4,243,818 and 4,348,543 and British Patent 1,043,507.

Alternatively or in addition, polyol (b3) optionally has at least one tertiary nitrogen in a molecular chain, such as is formed by using, for instance, an alkyl-aziridine as co-monomer with PO and EO.

Alternative, polyols useful in the practice of the invention as polyol (b3) include polyols with tertiary amine end-cappings, which are those with a tertiary amino group linked to at least one tip of a polyol chain. These tertiary amines are optionally such molecules as N,N-dialkylamino, N-alkyl, aliphatic or cyclic, amines, polyamines or combinations thereof.

Overall autocatalytic polyols (b3) preferably have at least about 2 and independently preferably at most about 8, more preferably at most about 6, and most preferably at most about 3, primary or secondary or a combination thereof hydroxyl groups per molecule and have a hydroxyl number of preferably at least about 15, more preferably at least about 20, most preferably at least about 30 optionally and independently to preferably at most about 200, more preferably at most about 180, most preferably at most about 170. The viscosity of the polyol (b3) measured at 25° C. is advantageously less than about 10,000 mPa·s, preferably less than about 8,000 mPa·s. While use of polyol (b3) or a combination thereof is optional in the practice of the invention, it is preferably present in an amount of at least about 1, more preferably at least about 5, most preferably at least about 10; optionally to preferably at most about 50 weight percent of the total polyols or polyol composition in making a molded foam, more preferably at most about 20, weight percent of the total polyols or polyol composition in the case of slabstock foams, most preferably at most about 5 weight percent based on total polyol weight.

One or more crosslinkers are optionally present in the flexible foam formulation, in addition to the polyols described above. This is particularly the case when making high resilience slabstock or molded foam. If used, amounts of crosslinkers used are preferably at least about 0.1, more preferably at least about 0.25, and preferably at most about 1, more preferably at most about 0.5 part by weight, per 100 parts by weight of total polyols.

For purposes of this invention “crosslinkers” are materials having three or more isocyanate-reactive groups per molecule and preferably an equivalent weight per isocyanate-reactive group of less than about 400. Crosslinkers preferably have at least about 3 and preferably at most about 8, more preferably about 4 hydroxyl, primary amine or secondary amine groups per molecule and have an equivalent weight of preferably at least about 30, more preferably at least about 50 and, independently preferably at most about 200, more preferably at most about 125. Examples of suitable crosslinkers include diethanol amine, monoethanol amine, triethanol amine, mono- di- or tri(isopropanol)amine, glycerine, trimethylol propane, pentaerythritol, sorbitol and the like.

It is also possible to use one or more chain extenders in the foam formulation. For purposes of this invention, a chain extender is a material having two isocyanate-reactive groups per molecule and an equivalent weight per isocyanate-reactive group of preferably less than about 400, preferably at least about 31 and more preferably at most about 125. The isocyanate reactive groups are preferably hydroxyl, primary aliphatic or aromatic amine or secondary aliphatic or aromatic amine groups. Representative chain extenders include amines ethylene glycol, diethylene glycol, 1,2-propylene glycol, dipropylene glycol, tripropylene glycol, ethylene diamine, phenylene diamine, bis(3-chloro-4-aminophenyl)methane and 2,4-diamino-3,5-diethyl toluene. If used, chain extenders are typically present in an amount of preferably at least about 1, more preferably at least about 3 and, independently preferably at most about 50, more preferably at most about 25 parts by weight per 100 parts by weight high equivalent weight polyol.

The use of such crosslinkers and chain extenders is known in the art as disclosed in U.S. Pat. No. 4,863,979 and EP Publication 0 549 120.

In utilizing the NOBP in the present invention, a polyether polyol is optionally included in the formulation, that is, as part of polyol (b2), to promote the formation of an open-celled or softened polyurethane foam. Such cell openers are disclosed in U.S. Pat. No. 4,863,976, the disclosure of which is incorporated here by reference. Such cell openers generally have a functionality of at least about 2, preferably at least about 3 and preferably at most about 12, more preferably at most about 8, and a molecular weight of at least 5,000 up to about 100,000. Such polyether polyols contains at least 50 weight percent oxyethylene units, and sufficient oxypropylene units to render them compatible with other components of the foam formulation. The cell openers, when used, are preferably present in an amount of at least about 0.2 and preferably at most about 5, more preferably at most about 3 parts by weight of the total polyol. Examples of commercially available cell openers are VORANOL* Polyol CP 1421 and VORANOL* Polyol 4053 (this polyol has a functionality of 6 since it is sorbitol initiated); VORANOL is a trademark of The Dow Chemical Company.

To produce a polyurethane foam, a blowing agent is required. In the production of flexible polyurethane foams, water is preferred as a blowing agent in most instances. The amount of water is preferably at least about 0.5, more preferably at least about 2, and independently preferably at most about 10, more preferably at most about 7 parts by weight based on 100 parts by weight of the total polyol. Other blowing agents and their uses are well within the skill in the art. For instance, carboxylic acids or salts are optionally used as reactive blowing agents. Other blowing agents include liquid or gaseous carbon dioxide, methylene chloride, acetone, pentane, isopentane, methylal or dimethoxymethane, dimethylcarbonate, or a combination thereof. Use of artificially reduced or increased atmospheric pressure, as described in U.S. Pat. No. 5,194,453, is also contemplated in the practice of the present invention. A foam is optionally blown with any one or any combination of such agents or means.

In addition to the foregoing components, it is often desirable to employ certain other ingredients in preparing polyurethane polymers. Among these additional ingredients are emulsifiers, silicone surfactants, preservatives, flame retardants, colorants, antioxidants, reinforcing agents, fillers, including recycled polyurethane foam in form of powder, or a combination of these with or without other additives.

One or more catalysts for the reaction of the polyol composition and, optionally, water with the polyisocyanate are used. In the practice of the invention, at least one catalyst containing bismuth is used. Catalytic bismuth compounds include, for instance, bismuth carboxylates such as acetate, oleate, octoate or neodecanoate, for example, bismuth nitrate, bismuth halides such as bromide, chloride or iodide, for example, bismuth sulfide, basic bismuth carboxylates such as bismuth neodecanoate, bismuth subgallate or bismuth subsalicylate, for example, and combinations thereof. Each bismuth catalyst is preferably an organobismuth catalyst. Such organobismuth catalysts include, for instance, carboxylates and sulfonates, which are preferred among the organobismuth catalysts. Examples of sulfonates include aromatic sulfonates such as p-toluenesulfonate and aliphatic sulfonates such as methanesulfonate and trifluoromethanesulfonate. The bismuth catalyst more preferably includes at least one bismuth carboxylate, such as 2-ethylhexanoate, stearate, tris(2-ethyl-hexaoctoate) or octoate, decanoate, preferably the carboxylate of carboxylic acids having preferably at least 2, more preferably at least 5, most preferably at least 8 carbon atoms, and advantageously at most about 20, preferably at most about 17, more preferably at most about 15, most preferably at most about 12 carbon atoms, and of such carboxylic acids, preferably aliphatic acids. The most preferred catalyst for the present invention is bismuth neodecanoate. Even more preferred is a low acid (less than 34 percent free acid) organometallic catalyst, especially bismuth neodecanoate, as described in U.S. Pat. No. 6,825,238 which is incorporated by reference herein to the extent permitted by law.

The level of bismuth catalyst or combination thereof employed for forming the polyurethane s preferably at least about 0.05, more preferably at least about 0.07, most preferably at least about 0.1; and optionally at preferably at most about 5, more preferably at most about 3, most preferably at most about 2 PPHP based on weight of total polyols in the reaction being catalyzed. That is, when the bismuth catalyst is used to catalyze, for instance formation of a prepolymer, the total weight of polyols as a basis for determining the amount of catalyst to use is the weight of all polyols going to make up the prepolymer. Similarly, when the reaction in question includes, for instance, a hydroxy functional prepolymer and other polyols to react with isocyanate, the total prepolymer weight includes that of the hydroxyl functional prepolymer and other polyols entering into reaction to form a polyurethane. The use of bismuth catalyst in any stage of polyurethane formation, that is, formation of at least one prepolymer, formation of a final polyurethane or a combination thereof is within the practice of the invention. It is preferred to use the bismuth catalyst at least in the formation of the final polyurethane, whether or not one or more prepolymers is involved in an earlier or intermediate stage and whether or not at least one bismuth catalyst is involved in any earlier or intermediate stage that optionally occurred.

In addition to the bismuth catalyst, any catalyst suitable to form urethanes catalyst is optionally used. Such catalysts include tertiary amine compounds, amines with isocyanate reactive groups and organometallic compounds. Exemplary tertiary amine compounds include triethylenediamine, N-methylmorpholine, N,N-dimethylcyclohexylamine, pentamethyldiethylenetriamine, tetramethylethylenediamine, bis(dimethylaminoethyl)ether, 1-methyl-4-dimethylaminoethyl-piperazine, 3-methoxy-N-dimethylpropylamine, N-ethylmorpholine, dimethylethanolamine, N-cocomorpholine, N,N-dimethyl-N′,N′-dimethyl isopropylpropylenediamine, N,N-diethyl-3-diethylamino-propylamine, dimethylbenzylamine and combinations thereof. Exemplary organometallic catalysts include organomercury, organolead, organoferric, organotin, organolithium and combinations thereof. Among the various additional catalysts, nitrogen-containing compounds such as those listed are preferred. Some additional catalyst, preferably containing nitrogen, is often particularly useful when the bismuth catalyst is other than a carboxylate.

When at least one nitrogen containing catalyst, preferably an amine catalyst, is used with at least one bismuth catalyst the amount of nitrogen-containing catalyst or combination thereof is preferably at least about 0.05, more preferably at least about 0.08, most preferably at least about 0.1; and optionally at preferably at most about 5, more preferably at most about 4, most preferably at most about 2 PPHP based on weight of total polyols in the reaction being catalyzed. Preferably the foam of the present invention is substantially free of tin, lead, or mercury, more preferably substantially free of all three.

Processing for producing polyurethane products are well known in the art. In general components of the polyurethane-forming reaction mixture may be mixed together in any convenient manner, for example by using any of the mixing equipment and process described in the prior art for the purpose such as described in “Polyurethane Handbook”, by G. Oertel, Hanser publisher.

In general, the polyurethane foam is prepared by mixing the polyisocyanate and polyol composition in the presence of at least one blowing agent, at least one catalyst and other optional ingredients as desired, under conditions such that the polyisocyanate and polyol composition react to form a polyurethane and/or polyurea polymer while the blowing agent generates a gas that expands the reacting mixture. The foam is optionally formed by the so-called prepolymer method, as described in U.S. Pat. No. 4,390,645, for example, in which a stoichiometric excess of the polyisocyanate is first reacted with the high equivalent weight polyol(s) to form a prepolymer, which is in a second step reacted with a chain extender and/or water to form the desired foam. Frothing methods, as described in U.S. Pat. Nos. 3,755,212; 3,849,156 and 3,821,130, for example, are also suitable. So-called one-shot methods, such as described in U.S. Pat. No. 2,866,744, are preferred. In such one-shot methods, the polyisocyanate and all polyisocyanate-reactive components are simultaneously brought together and caused to react. Three widely used one-shot methods, which are among the methods suitable for use in this invention, include conventional slabstock foam processes, high resiliency slabstock foam processes, viscoelastic foam slabstock process and molded foam methods.

When a prepolymer is used in forming a polyurethane according to the practice of the invention, part or all of any of the polyols defined as (b1), (b2) or (b3) are optionally reacted with either a stoichiometric excess of at least one isocyanate to produce prepolymers having isocyanate functionality or with a stoichiometric deficiency of at least one isocyanate to produce at least one polyol-terminated prepolymer. An isocyanate functional prepolymer would preferably be reacted with additional polyol to form a polyurethane of the invention while a polyol functional prepolymer would preferably be reacted with additional isocyanate to produce a polyurethane of the invention. A polyol functional prepolymer is preferably admixed with remaining unreacted polyol, either of the same or different composition as that polyol used in preparation of the prepolymer, for reaction with the additional isocyanate. When prepolymers are used, the polyol composition of the invention is considered to be the total polyol combination (b) used in the practice of the invention is the combination of all polyols used in making the prepolymers, further reacting with the prepolymers, used with the prepolymers or separate from them in further reaction with isocyante or a combination thereof. In each instance one or more of the polyols making up (b1), (b2), (b3) or a combination thereof is used in the prepolymer and the remainder of (b) is used in making the final polyurethane. Optionally, several steps of reaction are used.

Slabstock foam is conveniently prepared by mixing the foam ingredients and dispensing them into a trough or other region where the reaction mixture reacts, rises freely against the atmosphere (sometimes under a film or other flexible covering) and cures. In common commercial scale slabstock foam production, the foam ingredients (or various mixtures thereof) are pumped independently to a mixing head where they are mixed and dispensed onto a conveyor that is lined with paper or plastic. Foaming and curing occurs on the conveyor to form a foam bun. The resulting foams are advantageously preferably at least about 10 kg/m³, more preferably at least about 15, most preferably at least about 17 kg/m³, and independently preferably at most about 100, more preferably at most about 90, most preferably at most about 80 kg/m³ in density.

A preferred slabstock foam formulation contains preferably at least about 1, more preferably at least about 1.2, and preferably at most about 6, more preferably at most about 5 parts by weight water are used per 100 parts by weight high equivalent weight polyol at atmospheric pressure. At reduced pressure these levels are optionally reduced. On another hand, if pressure is increased, these water level sometimes need to be increased.

High resilience slabstock (HR slabstock) foam is made in methods similar to those used to make conventional slabstock foam but using higher equivalent weight polyols. HR slabstock foams are characterized in exhibiting a ball rebound score of at least 40 percent measured according to the procedures of ASTM 3574.93. Water levels tend to be from about 2 to about 6, especially from about 3 to about 5 parts per 100 parts by weight of polyols. In contrast, viscoelastic foams often contain lower equivalent weight polyols and have ball rebound values below 25 percent as measured according to the procedure of ASTM 3574.93. Water levels tend to be from about 1 to about 3, especially from about 1.1 to about 2.5 parts by weight of polyol.

Molded foam can be made according to the invention by transferring the reactants (polyol composition, polyisocyanate, blowing agent, and surfactant) to a closed mold where the foaming reaction takes place to produce a shaped foam. Either a so-called “cold-molding” process, in which the mold is not preheated significantly above ambient temperatures, or a “hot-molding” process, in which the mold is heated to drive the cure, are optionally used. Cold-molding processes are preferred to produce high resilience molded foam, that is, foam having resiliency above about 40 percent using the ball rebound test. Densities for molded foams often range from 30 to 50 kg/m³.

The applications for foams produced by the present invention are those known in the art or within the skill in the art. For instance, flexible, semi-rigid and viscoelastic foams find use in applications such as bedding, furniture, shoe innersoles, automobile seats, sun visors, packaging applications, armrests, door panels, noise insulation parts, other cushioning and energy management applications, dashboards and other applications for which conventional flexible polyurethane foams are used, as described in “Polyurethane Handbook” by G. Oertel et al, Hanser publisher.

Viscoelastic foams produced according to the invention have fine cells. This is very important for pillow applications. Prior to the present invention, fine cell structure had not previously been obtained in viscoelastic foams using TDI and natural oil polyols in amounts greater than about 10 PPHP based on total polyol. Fine cell structure is indicated by the number of cells per inch of at least 50, preferably at least about 55, more preferably at least about 60 cells per inch (19.7, 21.6, or 23.6 cells per cm, respectively) as measured visually or by computerized measurement. Thus, the present invention includes foams having a resilience of at most 25 percent as measured according to ASTM D3574 Test H, made using at least about 10 PPHP natural oil polyol and having an average number of cells per inch of at least 50 (at least about 19.7 cells /cm) The number of cells per inch or centimeter are counted either visually using a magnifying glass or a microscope or can be measured by computer imaging and software for the purpose. The number of cells is determined by drawing a line of predetermined length with a black marker on the foam surface and counting the cells crossing this line.

Objects and advantages of this invention are further illustrated by the following examples. The particular materials and amounts thereof, as well as other conditions and details, recited in these examples should not be used to limit this invention. Rather they are illustrative of the whole invention. Unless stated otherwise all percentages, parts and ratios are by weight. Examples of the invention are numbered while comparative samples, which are not examples of the invention, are designated alphabetically.

### EXAMPLES

A description of the raw materials used in the examples is as follows.
CAT-1 is stannous octoate is commercially available from Degussa-Goldschmidt under the trade designation Cosmos 29.
CAT-2 is bismuth neodecanoate commercially available from Air Products & Chemicals Inc. under the trade designation Dabco MB 20
CAT-3 is a tertiary amine catalyst commercially available from Air Products & Chemicals Inc. under the trade designation Dabco 33 LV
CAT-4 is a tertiary amine catalyst commercially available from Momentive Performance Materials under the trade designation Niax A-1.
CAT-5 is a tertiary amine catalyst commercially available from Momentive Performance Materials under the trade designation Niax A-300
CAT-6 is 99% pure diethanolamine available from Aldrich
SUR-1 is a silicone based surfactant commercially available from Degussa-Goldschmidt under the trade designation Tegostab B-8948.
SUR-2 is a silicone based surfactant commercially available from Momentive Performance Materials under the trade designation Niax L-627.
SUR-3 is a silicone based surfactant commercially available from Degussa-Goldschmidt under the trade designation Tegostab B 8715LF
PEPO-1 is a 1,200 equivalent weight polyoxypropylene/polyoxyethylene polyol initiated with of glycerol commercially available from The Dow Chemical Company under the trade designation Voranol CP 3322.
PEPO-2 is a 235 equivalent weight propoxylated triol commercially available from The Dow Chemical Company under the trade designation Voranol HT 760.
PEPO-3 is a BO (butylene oxide) based monol commercially available from The Dow Chemical Company under the trade designation XQ-82211.00.
PEPO-4 is a 1,700 equivalent weight propoxylated polyol with 15% EO capping and initiated with a blend of glycerol and sorbitol having a nominal functionality of 4.2 commercially available from The Dow Chemical Company under the trade designation Specflex NC 630E
PEPO-5 is a SAN copolymer polyol available from The Dow Chemical Company under the trade designation Specflex NC 700
PEPO-6 is a 60/40 blend of PEPO-4 and 1,700 equivalent weight propoxylated tetrol with 15% EO capping, initiated with 3,3′-diamino-N-methyldipropylamine commercially available from The Dow Chemical Company under the trade designation Voranol Voractiv 6340.
NCO-1 is TDI 80/20 (2,4-/2,6-isomers) isocyanate commercially available from The Dow Chemical Company under the trade designation VORANATE T-80.
NOBP A is a 3-functional natural oil polyol prepared using fatty acids from soy oil and has a primary hydroxyl content of 100 percent with a hydroxyl number (OH #) of 89. It is made by reacting hydroxymethylated soybean fatty acid methyl esters with a 625 molecular weight poly(ethylene oxide) triol made by ethoxylation at 120° C. of glycerol until an equivalent weight of 209 is reached using 0.3 percent final level of KOH and finishing with synthetic magnesium silicate as known in the skill in the art and taught in such references as Polyurethane Handbook, Chemistry, Raw Materials, Processing, Application, Properties edited by G. Oertel, Hanser publisher (1993, second edition) section 3.1.1.2, at a 4:1 molar ratio, using 500 ppm of stannous octoate as the catalyst. The resulting polyether-polyester has a viscosity of 2,700 mPa·s at 21° C., a hydroxyl equivalent weight of 640, Mn of 2500, Mw of 3550, and a polydispersity of 1.44. NOPO-A has an average of approximately 3.0 hydroxyl groups/molecule. NOPO-1 contains approximately 70 percent Natural Oil.
NOPO-B is a natural oil polyol commercially available from Cargill, Inc. under the trade designation BiOH, which is prepared by a process different from that used to make NOPO-1 (see WO 2006/116456) and has 100 percent secondary hydroxyl groups. NOPO-B contains approximately 90 percent Natural Oil.

All free rise foams are made in the laboratory by preblending in a plastic cup polyols, surfactants if used, crosslinkers, catalysts and water, conditioned at about 25° C. Isocyanate is also conditioned at about 25° C. Components are stirred at 1,200 RPM for 30 seconds before the isocyanate is added and mixed for another 5 seconds. Machine made foam is produced using a Polymech slabstock machine according to manufacture's directions.

Foam properties are measured according to ASTM D 3574-83 test methods, unless otherwise indicated.

### Examples 1, 2, and Comparative Samples A and B

Free rise foam are made by the laboratory method previously described using 20×20×20 cm cardboard boxes into which the stirred components are poured for foam formation and full expansion. The resulting pads are left to cool at room temperature overnight, then they are visually observed for dimensional changes (shrinkage) or for voiding (split on the side of the bun).

TABLE 1
Components for Ex 1 and 2 and CS A
and B in PPHP unless stated otherwise

| | Example or Comparative Sample | | | |
|---|---|---|---|---|
| | 1 | 2 | A* | B* |
| PEOP-1 | 60 | 60 | 60 | 60 |
| NOBP-A | 40 | 40 | 40 | 40 |
| Water | 2.8 | 2.8 | 2.8 | 2.8 |
| CAT-4 | 0.1 | 0.1 | 0.1 | 0.1 |
| CAT-3 | 0.15 | 0.15 | 0.15 | 0.15 |
| SUR-1 | 1.0 | 1.0 | 1.0 | 1.0 |
| CAT-2 | 0.22 | 0.26 | | |
| CAT-1 | | | 0.12 | 0.15 |
| NCO-1 (index) | 105 | 105 | 105 | 105 |
| Foam shrinkage | No | No | Slight <8% | Total |
| Density (Kg/m³) | 36.8 | 38.3 | 34.1 | NA |
| Airflow (cfm) | 1.3 | 0.9 | 1.1 | NA |
| Airflow converted to (l/s) | 0.613 | 0.425 | 0.519 | |
| 75% Compression Set | 9.3 | 18.3 | 14 | NA |

Comparative Samples A* and B* are comparative examples, not part of this invention.
NA means not applicable.

When bismuth neodecanoate is used to catalyze foam based on NOBP a good processing range is obtained, while stannous octoate gives foam shrinkage, in both cases. Foam B is unusable.

### Examples 3 and 4

Viscoelastic polyurethane foams are produced on as previously described machine. Polyol output is 20 kg/m³, conveyor speed is 3 m/min and width is 80 cm.

TABLE 2
Components for Ex 3 and 4 in PPHP unless stated otherwise

| Example | 3 | 4 | C |
|---|---|---|---|
| NOBP-A | 50 | 50 | 50 |
| PEOP-2 | 50 | 50 | 50 |
| Water | 1 | 2 | 2 |
| CAT-4 | 0.17 | 0.17 | 0.17 |
| CAT-3 | 0.33 | 0.33 | 0.33 |
| CAT-2 | 0.06 | 0.06 | |
| CAT-1 | | | 0.03 |
| SUR-2 | 0.6 | 1.2 | 1.2 |
| PEPO-3 | 2 | 2 | 2 |
| NCO-1 (index) | 90 | 90 | 90 |
| Bun Height | About 20 | About 30 | About 30 |
| measured in the | | | |
| center (cm) | | | |
| Core density (kg/m3) | 80 | 43 | 44 |
| Airflow (cfm) | 0.6 | 1.3 | 0.4 |
| Airflow converted to | 0.28 | 0.61 | 0.19 |
| (liter/sec) | | | |
| Ball Rebound (%) | 4 | 6 | 5 |
| Number of cells per | | 75 | 42 |
| inch | | | |

Viscoelastic foams of examples 5 and 6 catalyzed with bismuth decanoate and based on NOPB A have exceptionally fine cells, with more than 70 cells per inch, a figure not achieved with stannous octoate as shown by Comparative Sample C, and, in addition, exhibit acceptable airflow values

### Examples 5, and 6 and Comparative Samples D and E

All foams are made in a laboratory using the procedure of Example 1 and formulations indicated in Table 3.

TABLE 3
Examples 5, 6 and Comparative Samples C and D

| Example | 5 | D | E | 6 |
|---|---|---|---|---|
| PEOP-1 | 40 | 60 | 60 | 60 |
| NOBP-A | 40 | 30 | | 40 |
| NOBP-B | 20 | 10 | 40 | |
| Water | 2.8 | 2.8 | 2.8 | 2.8 |
| Cat-4 | 0.1 | 0.1 | 0.1 | 0.1 |
| Cat-3 | 0.30 | 0.15 | 0.15 | 0.15 |
| SUR-1 | 1.0 | 1.0 | 1.0 | 1.0 |
| CAT-2 | 0.24 | | | 0.3 |
| CAT-1 | | 0.12 | 0.14 | |
| T-80 NCO | 105 | 105 | 105 | 105 |
| index | | | | |
| Observation | No shrinkage, | Shrink- | Total | Voiding |
| after foam | no voiding | age >8%, | collapse | |
| curing | | Foam very | | |
| | | tight, not | | |
| | | testable | | |

Example 5 shows that good foam, based on a combination of NOBP-A and NOBP-B, can be produced with the bismuth neodecanoate catalyst, while it is not the case with stannous octoate (Comparative Sample C) although foam collapse is observed with comparative Sample D. Surprisingly, increasing the level of Bismuth neodecanoate to 0.3 and 0.4 parts (Examples 6 and 7) gives foam voiding. This is totally unexpected since one skilled in the art would expect foam shrinkage instead. This observation demonstrates that shrinkage free foam can be produced with the present invention.

### Examples 8 and 9

Two HR molded foams are produced using a mixing speed of 2,000 RPM and by pouring the reactants in a 30×30×10 cm aluminum mold heated at 60° C. and sprayed with a lubricant commercially available from Chem-Trend under the trade designation Klueber 41-2038 the release agent. Demolding time is 5 minutes. Formulations are described in Table 4:

TABLE 4
FLEXIBLE HR MOLDED FOAMS

| Example | 8 | 9 |
|---|---|---|
| PEPO-4 | 60 | 27.75 |
| PEPO-5 | 10 | 10 |
| PEPO-6 | | 32.25 |
| NOBP-A | 30 | 30 |
| Water | 4.1 | 4.1 |
| CAT-2 | 0.1 | 0.05 |
| CAT-3 | 0.3 | 0.3 |
| CAT-4 | 0.05 | |
| CAT-5 | 0.1 | 0.1 |
| CAT-6 | 0.7 | 0.7 |
| SUR-3 | 0.8 | 0.8 |
| NCO-1 index | 90 | 90 |
| Mold exit time (s) | 34 | 42 |
| Foam density (kg/m3) | 32.1 | 33.1 |
| Foam aspect | Well cured, | Well cured, |
| | no shrinkage | no shrinkage |

By combining Bismuth neodecanoate catalyst with an amine initiated polyol PEPO-6 (exemplifying polyol (b3)) a well cured foam having desirable physical characteristics is obtained.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

Embodiments of the invention include:
1. A process for producing a polyurethane product comprising steps of (a) supplying at least one polyisocyanate (b) supplying at least one polyol composition comprising at least about 5 weight percent based on total weight of polyols of at least one natural oil based polyol (b1) having a hydroxyl number of at most about 300 and a viscosity below about 10000 mPa·s; and (c) exposing the polyisocyanate and the polyol composition to reaction conditions such that urethane bonds are formed, wherein reaction conditions include the presence of at least one bismuth catalyst.
2. A polyurethane foam produced by the practice of the invention, preferably having a density of less than about 100 kg/m³.
3. A polyurethane foam having a resilience of at most 25 percent as measured according to ASTM D3574 Test H, made using at least about 10 PPHP natural oil polyol and having a number average of cells per centimeter of at least about any of 19.7, 21.6 or 23.6.
4. The process or foam of any preceding embodiment wherein the natural oil polyol or combination thereof (b1) comprises from at least about any of 5, 10, 25, 35, or 50 to at most about any of 75, 80, 85, 90, 95 or 100 weight percent of the total polyols used in preparing the polyurethane.
5. The process or foam of any preceding embodiment wherein each natural oil polyol (b1) is based on (derived from) any vegetable or animal oil, and each natural oil polyol independent is preferably an oil composed of triglycerides, more preferably having at least about any of 70 or 80 percent unsaturated acids, most preferably derived from soybean, castor, canola oils or a combination thereof.
6. The process or foam of any preceding embodiment wherein at least one natural oil polyol (b1) has at least one hydroxyl group per molecule introduced into the natural oil or derivative thereof, preferably using at least one of epoxidation, air blowing, other oxidation, hydroformylation followed by reduction or a combination thereof, optionally where such processes as alkylation or grafting are also used.
7. The process or foam of any preceding embodiment wherein (b1) comprises at least two different natural oil polyols (b1), preferably wherein the polyols differ in the processes by which they are made, preferably wherein at least two natural oil polyols are sufficiently different to result in improved physical or processing properties, satisfactory properties at a higher level of renewable resources, more preferably at least about 2 weight percent higher level; or when using a larger amount of combined natural oil polyols, in a resulting polymeric product or a combination thereof, all as compared with essentially the same end product produced by essentially the same process but using one of the natural oil polyols alone in an amount equal to that of the combination of natural oil polyols; independently preferably wherein the processes differ by at least one of reaction temperature, reaction time, reaction pressure or a combination thereof, more preferably by more than one of reaction temperature, reaction time, reaction pressure, catalyst, most preferably by at least one unit operation, or a combination thereof; preferably wherein at least the first process involves at least one unit operation of hydroformylation, epoxidation, alkoxylation, esterification, transesterification, alcoholysis, oxidation, ring opening using a natural oil or derivative thereof while the second process does not involve at least one of the listed unit operations used in preparing the first polyol or involves at least one additional unit operation or, a combination of both, most preferably wherein at least two natural oil polyols represent different members of the group consisting of triethanolamine alcoholyzed peroxy acid hydroxylate, epoxidized vegetable oil at least partially ring opened to produce a secondary hydroxyl group on a main vegetable oil chain, hydroformylated vegetable oil where the formyl groups have been at least partially converted to hydroxymethyl groups; air blown vegetable oil (not alkoxylated or further treated), alkoxylated air blown vegetable oil, transesterified air blown oil; fatty acid alcohol alkoxylates; transesterified vegetable oil, alkoxylated vegetable oil; alkoxylated polyester polyol, polyester polyol, polyetherpolyester polyol, initiated fatty acid polyester alcohol; epoxy ring-opening oligomer, and natural polyol.
8. The process or foam of any preceding embodiment wherein (b1) comprises at least two different natural oil polyols (b1) which differ by at least one of the following:
   percentage of hydroxyl groups that are primary as compared to
   secondary;
   hydroxyl functionality;
   molecular weight;
   hydrophilicity (level of ethylene oxide); or
   natural oil raw material.
9. The process or foam of any preceding embodiment wherein (b1) comprises at least two different natural oil polyols (b1) which differ in (a) percentage of primary and secondary hydroxyl groups wherein at least one of the different natural oil polyols has at least about 50 percent of its hydroxyl groups as primary, while at least one different natural oil polyol has at least about 51 percent of its hydroxyl groups as secondary; (b) hydroxyl functionality by at least about 10 percent; (c) molecular weight differing by at least about 10 percent; (d) hydrophilicity, differing by at least about 10 percent in level of ethylene oxide incorporated into the polyol molecules; (e) in originating from different natural oil raw materials, (f) in having a difference in fatty acid distribution as reflected in at least about a 10 weight percent difference in the level of any fatty acid or ester; or a combination thereof.
10. The process or foam of any preceding embodiment wherein (b1) comprises at least two different natural oil polyols (b1) wherein at least one of the natural oil polyols is at least one initiated fatty acid polyester alcohol.
11. The process or foam of any preceding embodiment wherein (b1) comprises at least two different natural oil polyols (b1) wherein at least one natural oil polyol comprises at least one natural oil polyol which has been oxidized or epoxidized in some stage of its preparation.
12. The process or foam of any preceding embodiment wherein at least one to natural oil polyol (b1) wherein at least one natural oil polyol comprises at least about 10 or 20 to about 40 or 60 weight percent molecular structures originating from ethylene oxide.
13. The process or foam of any preceding embodiment wherein at least one natural oil polyol (b1) or the blend of natural oil polyols making up (b1) has an average functionality of at least about any of 1.5, 1.8, or 2 to 6 or 5 or 4.
14. The process or foam of any preceding embodiment wherein at least one natural oil polyol (b1) or the blend of natural oil polyols making up (b1) has a hydroxyl number at most about any of 300, 200 or 100 mg KOH/g.
15. The process or foam of any preceding embodiment wherein at least one natural oil polyol (b1) has a viscosity of at most about any of 10,000; 8,000; 6,000 or 5,000 mPa·s measured at 25° C.
16. The process or foam of any preceding embodiment wherein the polyol composition comprises at least one additional (conventional) polyol, not prepared from a renewable resource (b2) and not autocatalytic.
17. The process or foam of any preceding embodiment wherein the additional polyol or combination thereof (b2) comprises from at least about any of 0, 5, 10 or 20 to at most about any of 80, 60 or 50 weight percent of the total polyols used in preparing the polyurethane.
18. The process or foam of any preceding embodiment wherein at least one additional polyol (b2) has a hydroxyl functionality of from 2 to at most about any of 3, 4, 5, 6, or 8.
19. The process or foam of any preceding embodiment wherein at least one additional polyol (b2) has a hydroxyl number of preferably at least about any of 15, 32, or 45 and, optionally at most about any of 200, 180, or 170.
20. The process or foam of any preceding embodiment wherein at least one additional polyol (b2) is selected from polyether polyols, polyester polyols, polymer polyols or a combination thereof.
21. The process or foam of any preceding embodiment wherein at least one additional polyol (b2) has a viscosity of at most about any of 10,000 or 8,000 mPa·s measured at 25° C.
22. The process or foam of any preceding embodiment wherein the polyol composition comprises at least one autocatalytic polyol (b3).
23. The process or foam of any preceding embodiment wherein the autocatalytic polyol or combination thereof (b3) comprises from at least about any of 0, 1, 5, or 10 to at most about any of 50, 20, or 5 weight percent of the total polyols used in preparing the polyurethane, the limitation to at most 5 percent being specific to molded foam and the limitation to at least 10 percent being specific to slabstock foam.
24. The process or foam of any preceding embodiment wherein at least one autocatalytic polyol (b3) is selected from amine initiated polyols, polyols having tertiary amine groups, alkoxylation products of amine initiators; compounds having at least one tertiary nitrogen in a molecular chain, compounds with tertiary amine end caps or combinations thereof.
25. The process or foam of any preceding embodiment wherein at least one autocatalytic polyol (b3) has a hydroxyl functionality of from 2 to at most about any of 3, 4, 5, 6, or 8.
26. The process or foam of any preceding embodiment wherein at least one autocatalytic polyol (b3) has a hydroxyl number of preferably at least about any of 15, 20, or 30 and, optionally at most about any of 200, 180, or 170.
27. The process or foam of any preceding embodiment wherein at least one autocatalytic polyol (b3) has a viscosity of at most about any of 10,000 or 8,000 mPa·s measured at 25° C.
28. The process or foam of any preceding embodiment wherein at least one crosslinker is used, preferably in an amount of at least about any of 0.1 or 0.25, optionally to preferably at most about any of 0.5 or 1 PPHP of polyol.
29. The process or foam of any preceding embodiment wherein at least one chain extender is used, preferably in an amount of at least about any of 1 or 3, optionally to preferably at most about any of 30 or 50 PPHP of polyol.
30. The process or foam of any preceding embodiment wherein at least one cell opener is used, preferably in an amount of at least about 0.2 optionally to preferably at most about any of 3 or 5 PPHP and count as part of the (b2) polyol.
31. The process or foam of any of the preceding embodiments wherein at least one bismuth catalyst is selected from bismuth carboxylates such as acetate, oleate, octoate or neodecanoate, for example, bismuth nitrate, bismuth halides such as bromide, chloride or iodide, for example, bismuth sulfide, basic bismuth carboxylates such as bismuthyl neodecanoate, bismuth subgallate or bismuth subsalicylate, for example, and combinations thereof; preferably an organobismuth catalyst; more preferably selected from bismuth carboxylates and sulfonates, most preferably including at least one bismuth carboxylate which is preferably at least one bismuth compound of a carboxylic acid having preferably from at least about any of 2, 5 or 8 to at most about any of 20, 17 15 or 12 carbon atoms, more preferably a aliphatic bismuth carboxylate, most preferably bismuth decanoate, and independently most preferably is a low acid organobismuth catalyst.
32. The process or foam of any of the preceding embodiments wherein at least one bismuth catalyst or a combination of bismuth catalysts is present in an amount of at least about any of 0.05, 0.07 or 1, optionally at most about any of 5, 3 or 2 PPHP based on weight of total polyols in the reaction being catalyzed.
33. The process or foam of any of the preceding embodiments wherein at least one bismuth catalyst is used in combination with at least one nitrogen-containing catalyst, preferably at least one amine catalyst, more preferably at least one tertiary amine catalyst.
34. The process or foam of any of the preceding embodiments wherein at least one nitrogen containing catalyst or combination thereof is used and the nitrogen-containing catalyst or catalysts are present in an amount of preferably at least about any of 0.05, 0.08 or 0.1 to at most about any of 2, 4 or 5 PPHP based on total weight of polyols in the reaction being catalyzed.
35. The process or foam of any of the preceding embodiments wherein at least one prepolymer is formed from at least a portion of the polyol composition (b) and at least a portion of the polyisocyanate (a).
36. The process or foam of any of the preceding embodiments wherein at least one prepolymer has hydroxyl groups.
37. The process or foam of any of the preceding embodiments wherein at least one prepolymer is admixed with additional polyol composition for reaction with additional polyisocyanate.
38. The process or foam of any of the preceding embodiments wherein at least one prepolymer has isocyanate groups and is reacted with additional polyol composition.
39. The process or foam of any of the preceding embodiments wherein the portion of polyol composition used to make a prepolymer comprises polyol (b1).
40. The process or foam of any of the preceding embodiments wherein the portion of polyol composition used to make a prepolymer comprises polyol (b2).
41. The process or foam of any of the preceding embodiments wherein the portion of polyol composition used to make a prepolymer comprises polyol (b3).
42. The process or foam of any of the preceding embodiments wherein the portion of polyol composition used to make a prepolymer has a composition different from that used for subsequent reaction.
43. The process or foam of any of the preceding embodiments wherein the portion of polyol composition used to make a prepolymer has a composition the same as that used for subsequent reaction.
44. The process or foam of any of the preceding embodiments wherein the polyurethane product comprises at least one foam, preferably a flexible foam, more preferably having a density of less than 100 kg/m³.
45. The process or foam of any of the preceding embodiments wherein the polyurethane product comprises selected from at least one molded, slabstock, high resiliency, or viscoelastic foam.
46. The process or foam of any of the preceding embodiments wherein the polyol composition (b) comprises:
   (b1) from 5 to 100 percent of at least one polyol based on a renewable resource with a hydroxyl number below about 300.
   (b2) from 0 to 60 percent of at least one polyol that is neither autocatalytic nor based on a renewable resources having a nominal average functionality of from 2 to 8 and a hydroxyl number of from 15 to 200; and
   (b3) optionally at least one autocatalytic polyol having a nominal average functionality of 2 to 8 and a hydroxyl number of from 15 to 200, in an amount of from 1 to 50 weight percent of polyols, if used.
47. The process or foam of any of the preceding embodiments wherein a blowing agent, preferably comprising water is used, more preferably comprising at least about any of 0.5 or 2 to at most about 7 or 10 PPHP water based on total polyol composition weight.
48. The process or foam of any of the preceding embodiments wherein the polyol composition additionally comprises at least one additive, preferably comprising at least one surfactant, emulsifier, preservatives, flame retardant, colorant, antioxidant, reinforcing agent, filler, or combination thereof.
49. The process or foam of any of the preceding embodiments wherein the isocyanate is selected from toluene-2,4- and 2,6-diisocyanates or MDI or combinations of TDI and MDI.
50. The process or foam of any of the preceding embodiments wherein the isocyanate is used at an index of at least about any of 50, 69, 70, 75, 80, or 90, independently optionally to about any of 150, 140, 130, 120, 115, or 110.
51. The process or foam of any of the preceding embodiments wherein the foam is prepared in a slabstock process, preferably using an amount of water as blowing agent, the amount more preferably being from about any of 1 or 1.2 to at most about any of 5 or 6 PPHP based on polyol weight; independently, the process preferably comprises admixing the polyol composition and isocyanate and pouring or dispensing it into an open container, preferably a trough, or lined conveyer.
52. The process or foam of any of the preceding embodiments wherein the foam is prepared in a molded foam process, preferably using an amount of water as blowing agent, the process preferably comprises supplying the polyol composition and isocyanate to a closed form or mold where the foam forms.
53. The process or foam of any of the preceding embodiments wherein the foam is prepared using an amount of water from about any of 2 or 3 to at most about any of 5 or 6 PPHP based on polyol weight; such that a high resilience foam is formed having a resiliency of at least about 40 percent ball rebound.
54. The process or foam of any of the preceding embodiments wherein the foam is prepared using an amount of water from about any of 1 or 1.1 to at most about any of 2.5 or 3 PPHP based on polyol weight; such that a viscoelastic foam is formed having a resiliency of at most about 25 percent ball rebound.
55. The process or foam of any of the preceding embodiments which exhibits least one (or in order of increasing preference 2, 3, 4, or 5) of (a) wide processing window, that is a processing window greater than that observed in making a foam using the same formulation and process except that the catalyst is selected from tin octoate or dibutyl tin dilaurate, or preferably is at least about 25 percent of the total catalyst level (or amount) without substantial shrinkage, (b) a faster cure time than that observed using the same formulation and process except that stannous octoate is used for the catalyst; (c) the resulting foam has fine cells (smaller than about 60 cells per cm (about 23/cm)), (d) has relatively lower odor as compared with foams of the same formulation made using stannous octoate or (e) exhibits lower emission of VOC's as compared with foams of the same formulation made using stannous octoate or a combination thereof.
56. The process or foam of any of the preceding embodiments wherein at least one resulting foam has an airflow of at least about any of 0.6, 0.8 or 1.0 cfm (cubic foot per minute), (0.28317, 0.37756, 0.47195 liters/sec, respectively).
57. The process or foam of any of the preceding embodiments wherein at least one resulting foam is substantially shrinkage free.
58. The foam of any preceding embodiment used in at last one of bedding, furniture, shoe innersoles, automobile seats, sun visors, packaging applications, armrests, door panels, dashboards, noise insulation parts, other cushioning and energy management applications, or a combination thereof.
59.An article comprising at least one foam of any of the preceding embodiments.
60. The article of embodiment 59 which is at least one of bedding, furniture, shoe innersoles, automobile seats, sun visors, packaging applications, armrests, door panels, dashboards, noise insulation parts, other cushioning and energy management applications, or a combination thereof.

1-14. (canceled)

15. A method for producing a flexible a polyurethane foam having a density of less than about 100 kg/m³, the method comprising at least a reaction of a mixture of
a. at least one organic polyisocyanate with
b. a polyol composition comprising
(b1) from 5 to 100 percent by weight of at least one natural oil based polyol with a hydroxyl number below 300 and a viscosity below about 10000 mPa·s as measured at 25° C.;
(b2) from 0 to 60 percent by weight of at least one polyol compound other than (b2) having a nominal starter functionality of 2 to 8 and a hydroxyl number from 15 to 200; and
(b3) optionally from 1 to 50 percent by weight of an amine initiated polyol other than (b1) having a nominal starter functionality of 2 to 8 and an hydroxyl number from 15 to 200;
(c) in the presence of at least one polyurethane catalyst, comprising at least one catalyst for the reaction of isocyanate and hydroxyl groups which is a bismuth compound; and
(d) in the presence of 0.5 to 10 parts of water per hundred parts of polyol as blowing agent.

16-17. (canceled)

18. A polyurethane foam having a resilience of at most 25 percent as measured according to ASTM D3574 Test H, made using at least about 10 PPHP natural oil polyol and having a number average of cells per centimeter of at least about 19.7.

19. The method of claim 1 wherein (b1) comprises from at least about 10 to at most about 95 weight percent of the total polyols used in preparing the polyurethane with the remainder comprising at least one additional or conventional polyol (b2), at least one autocatalytic polyol (b3) or a combination thereof.

20. The method of claim 1 wherein (b1) comprises at least two different natural oil polyols (b1), preferably wherein the differences are in at least one of (a) processes by which they are made or (b) at least one of the following characteristics: (1) percentage of hydroxyl groups that are primary as compared to secondary; (2) hydroxyl functionality; (3) molecular weight; (4) hydrophilicity (level of ethylene oxide); or (5) natural oil raw material wherein at least two natural oil polyols are sufficiently different to result in improved physical or processing properties, satisfactory properties at a higher level of renewable resources, or when using a larger amount of combined natural oil polyols, in a resulting polymeric product or a combination thereof, all as compared with essentially the same end product produced by essentially the same process but using one of the natural oil polyols alone in an amount equal to that of the combination of natural oil polyols.

21. The method of claim 1 wherein (b1) comprises at least two different natural oil polyols (b1) wherein at least one of the natural oil polyols is at least one initiated fatty acid polyester alcohol.

22. The method of claim 1 wherein the additional polyol or combination thereof (b2) comprises from at least about 5 to at most about 80 weight percent of the total polyols used in preparing the polyurethane, has a nominal hydroxyl functionality of from 2 to 8; a hydroxyl number of from 15 to 200, a viscosity of at most about 10,000 mPa·s measured at 25° C.

23. The method of claim 1 wherein the additional polyol (b2) is selected from polyether polyols, polyester polyols, polymer polyols or a combination thereof.

24. The method of claim 1 wherein the autocatalytic polyol or combination thereof (b3) comprises from at least about 1 to at most about 50 weight percent of the total polyols used in preparing the polyurethane, has a hydroxyl functionality of from 2 to 8; a hydroxyl number of from 15 to 200, and a viscosity of at most about 10,000 mPa·s measured at 25° C.

25. The method of claim 1 wherein at least one bismuth catalyst is selected from bismuth carboxylates, bismuth nitrate, bismuth halide, bismuth sulfide, and combinations thereof.

26. The method of claim 1 wherein the bismuth catalyst comprises an organobismuth catalyst.

27. The method of claim 26 wherein the bismuth catalyst is a bismuth carboxylate.

28. The method of claim 26 wherein the bismuth catalyst or combination thereof is present in an amount of from 0.05 to 5 PPHP based on weight of total polyols in the reaction being catalyzed.

29. The method of claim 1 wherein at least one bismuth catalyst is used in combination with at least one nitrogen-containing catalyst.

30. The method of claim 1 wherein a tertiary amine catalyst is used in an amount of from 0.05 to 5 PPHP based on total weight of polyols in the reaction being catalyzed.

31. The method of claim 1 wherein at least one prepolymer is formed from at least a portion of the polyol composition (b) and at least a portion of the polyisocyanate (a).

32. A polyurethane foam produced by the method of claim 1.
